(19) United States
(12) Patent Application Publication
(10) Pub. No.: US 2012/0029882 A1
(43) Pub. Date: Feb. 2, 2012

(54) SYSTEM AND METHOD FOR GENERATING QUADRANGULATIONS

(76) Inventors: David Bommes, Aachen (DE); Henrik Zimmer, Aachen (DE); Leif Kobbelt, Aachen (DE)

(21) Appl. No.: 12/847,821

(22) Filed: Jul. 30, 2010

(51) Int. Cl. G06F 17/50

(52) U.S. Cl. 703/1

(57) ABSTRACT

A system and method for quadrangulating a triangle mesh is taught herein. After constructing an as smooth as possible symmetric cross field satisfying a sparse set of directional constraints (t) capture the geometric structure of the surface), the mesh is cut open in order to enable a low distortion unfolding. Then, a seamless globally smooth parametrization is computed whose iso-parameter lines follow the cross field directions. Notably, sparsely distributed directional constraints are sufficient to automatically determine the appropriate number, type and position of singularities in the quadrangulation. Both steps of the algorithm (cross field and parametrization) can be formulated as a mixed-integer problem which is solved very efficiently by an adaptive greedy solver, in order to generate high quality quad meshes in a fully automatic manner.

### FIELD OF THE INVENTION

The present invention relates generally to computer modeling and in particular to systems and methods for adaptive generation of quadrangulations.

### BACKGROUND OF THE INVENTION

The problem of generating high quality quad meshes from unstructured triangle meshes has received a lot of attention recently. The reason for this interest is that quad meshing converts raw geometric data into a higher representation which effectively supports sophisticated operations like texturing and shape modification of objects. The difficulties in quad meshing arise from the fact that the quality criteria are diverse and their optimization often requires the consideration of global dependencies. The most common quality aspects are:
a. Individual Element Quality: Each quad should be close to a rectangle or square, i.e. the four corner points should be coplanar, opposite edges should have equal length and the four interior angles should be 90 degrees.
b. Orientation: Away from flat or umbilic points on the surface, mesh edges should be orthogonal to the principal curvature directions such that the dihedral angle across edges captures these curvatures in a natural way.
c. Alignment: Sharp features of the surface should be explicitly represented by a sequence of mesh edges in order to minimize the Hausdorff-distance between triangulation and quadrangulation and to prevent normal noise.
d. Global Structure: Singularities, i.e. vertices with valence ≠4, are necessary to compensate for the Gaussian curvature. Their number and position must be chosen carefully to capture the global geometric structure, since otherwise the element quality and orientation is heavily affected.
e. Semantics: In some applications additional requirements emerge from the intended usage of the 3D model and cannot be derived from the geometry alone. In finite element simulation of deformation processes, e.g., the optimal mesh depends on the rest geometry as well as on the external forces and constraints.

A quadrangulation algorithm should optimize the output simultaneously with respect to all of these criteria. However, while element quality, orientation and alignment are rather simple, the global structure is much more difficult to handle. Consequently, a focus on automatically finding good singularity positions which optimize the global structure of the quadrangulation is desired.

Many prior art methods use smoothed (discrete) principal curvature directions to guide the quad meshing. The problem with these approaches is that the final singularity positions are effectively determined by the local smoothing operator applied to the initial curvature estimates. Especially in flat or umbilic regions where the initial directions have a random orientation, clusters of singularities may occur. Another problem is oversmoothing which may destroy the original orientation information in feature regions.

A lot of effort has been spent in the last number of years to compute high quality quadrangulations. Generally, there are two classes of approaches, namely explicit quadrangulations and parametrization based techniques. Examples of explicit approaches include those described in (i) Alliez et al. 2003, Anisotropic polygonal remeshing, ACM Trans. Graph, 22, 485-493 and Marinov and Kobbelt 2004, Direct anisotropic quad-dominant remeshing, Proceedings of the Computer Graphics and Applications, 12^{th} Pacific Conference, IEEE Computer Society, Washington, D.C., USA, 207-216, which trace curves along the principal curvature directions, and (ii) Lai et al. 2008, An incremental approach to feature aligned quad dominant remeshing, Proceedings of the 2008 ACM symposium on solid and physical modeling, 137-145, which iteratively transforms a triangular mesh into a quad-dominant mesh. For all such methods it is difficult to obtain coarse meshes consisting of quads only. Most structure aligned parametrization techniques are guided by vector or cross fields usually arising from estimated principal curvature directions or a manual design process. Cross fields are especially promising since they can capture singularities of fractional index which naturally arise in quadrangulations. Cross fields can be seen as four coupled vector fields. Consequently, smoothing algorithms must be able to handle the discretely switching vector assignments, which can be achieved by a non-linear angle formulation. However, such methods often get stuck in local minima and the result strongly depends on the initial solution.

Recently Ray et al. proposed a formalism to handle N-symmetry direction fields [Ray et al. 2008b, N-symmetry direction field design, ACM Trans. Graph. 25, 4, 1460-1485] in a linear manner, enabling the computation of globally smooth solutions. However, with this method all singularity positions must be prescribed by the user. In contrast, a method including an automatic search for singularity positions which enable the smoothest cross field for a set of sparse directional constraints is desired.

Besides the automatic singularity placement, another desired contribution not possible in the algorithm described by Ray et al. 2008b, is the smooth handling of multiple directional constraints. Their user-given hard angle constraints already fix the smoothness between multiple constraints, and do not exploit that the orientation of cross fields is invariant with respect to rotations by multiples of 90 degrees and that there might be rotations leading to a smoother cross field.

In the case of highly detailed geometry, a smooth cross field naturally requires lots of singularities which can be prevented by the smoothing algorithm of Ray et al., as described in Ray et al. 2008a, Periodic global parameterization, ACM Trans. Graph. 25, 4, 1460-1485. In contrast to this approach, a quadrangulation method which involves the interpretation of the cross field as an infinitely fine quadrangulation and computes all necessary singularities is preferred. The merging of singularities is later controlled by the parametrization which can perform singularity cancellations with respect to the given target edge length.

In the setting of conformal parametrizations, cone singularities as introduced by Kharevych et al. [Kharevych et al., 2006, Discrete conformal mappings via circle patterns, ACM Trans. Graph, 25, 2, 412-438] can be placed in a greedy manner at the local extrema of discrete conformal scaling factors [Ben-Chen et al., 2008, Conformal flattening by curvature prescription and metric scaling, Computer Graphics Forum, 27, 2 (April), 449-458]. These positions can be further improved by a nonlinear Gauss-Seidel solver [such as described in Springborn et al., 2008, Conformal equivalence of triangle meshes, SIGGRAPH '08: ACM SIGGRAPH 2008 papers, 1-11]. Both methods are designed to compute conformal parametrizations with a small number of cone singularities and lower distortion. Unfortunately, even when restricting to cross field cone singularities, the resulting positions are often not sufficient for structure aligned parametrizations where singularities are additionally induced by the desired orientations. Furthermore, supporting orientational constraints isn't straight forward in this formulation.

Structure Aware Parametrization techniques can be divided into two classes, namely high-level methods where the quad orientation is controlled by a rough patch layout and low-level methods where a desired orientation is given per triangle. Dong et al. used the Morse-Smale complex of Laplacian eigenfunctions [Dong et al. 2006, Spectral surface quadrangulation, ACM SIGGRAPH 2006 Papers, 1057-1066] to derive high-level patch layouts. Their method was extended in Huang et al. 2008, Spectral quadrangulation with orientation and alignment control, ACM Trans. Graph, 27, 5, 1-9, to enable the control over singularity positions, size, orientation and feature alignment. However, computing coarse high-quality results is still involved and requires an experienced user.

Ray et. al proposed a fully automatic non-linear parametrization technique which is guided by a low-level vector field and assumes a single chart for each triangle [Ray et al. 2006, Periodic global parameterization, ACM Trans. Graph. 25, 4, 1460-1485]. K\ddot{}alberer et al. developed a linear algorithm by mapping across field to a single vector field on a branched covering [K\ddot{}alberer et al., 2007, Quad-cover-surface parameterization using branched coverings, Computer Graphics Forum, 26, 3 (September), 375-384]. In this algorithm, a triangle based energy is optimized and the singularity positions are completely defined by the input cross field. However, the intermediate parametrization step (i.e. the integral of the hodge decomposed vector field which is incompatible at the cuts) involves a rounding of the coefficients of the transition functions at once, which results in lower quality quadrangulations.

In view of all of the foregoing, a need exists for a novel and inventive system and method for generating high quality quadrangulations which overcomes the aforedescribed deficiencies of the prior art, namely for efficiently computing coarse, oriented quadrangulations with naturally placed singularities.

### SUMMARY OF THE INVENTION

A system and method for generating high quality quadrangulations utilizes an algorithm for optimizing output, the system and method including an automatic search for singularity positions for a set of sparse directional constraints. The quadrangulation algorithm of the present invention is comprised of a two-step process, namely, cross field generation and global parametrization, which both reduce to a mixed-integer problem. The cross field generator takes sparsely scattered as well as densely distributed orientation constraints into account. By smoothly interpolating between the constraints, the system of the present invention can automatically place singularities at geometrically meaningful locations. Next, a globally smooth parametrization technique enables the generation of seamless quad meshes while satisfying various constraints such as orientation, alignment, and integer singularity locations. An optional anisotropic stretch metric enables a user to trade squareness of the quads for improved feature alignment. The system and method of the present invention utilize an adaptive greedy solver for mixed integer problems which only moderately increases the computation time compared to a continuous linear system solver. This is achieved by iterative rounding combined with local Gauss-Seidel updates in order to reduce the local residui. After applying the greedy mixed-integer solver, the result is a smooth cross field where the integer valued period jumps define type and position of all singularities. Although the overall method is designed to run fully automatic, a user can still manually override some decisions, for example, by manually shifting a singularity wherever it is necessary to take semantical side-conditions into account.

A system and method for quadrangulating a triangle mesh is taught herein. After constructing an as smooth as possible symmetric cross field satisfying a sparse set of directional constraints (to capture the geometric structure of the surface), the mesh is cut open in order to enable a low distortion unfolding. Then, a seamless globally smooth parametrization is computed whose iso-parameter lines follow the cross field directions. Notably, sparsely distributed directional constraints are sufficient to automatically determine the appropriate number, type and position of singularities in the quadrangulation. Both steps of the algorithm (cross field and parametrization) can be formulated as a mixed-integer problem which is solved very efficiently by an adaptive greedy solver, in order to generate high quality quad meshes in a fully automatic manner.

The present invention teaches a complete quadrangulation method which starts with a pre-process that finds reliable orientation constraints on an object. Based on these, possibly sparsely distributed, constraints, a smooth cross field is computed on the surface of the object. The global optimization produces a set of singularities that are automatically placed at geometrically meaningful locations. The cross field is used as input for a global parametrization technique which cuts the surface open into a disklike patch and then computes a planar embedding which takes orientation, alignment, as well as boundary compatibility constraints into account.

The system and method of the present invention is described in Bommes et al., August 2009, Mixed-Integer Quadrangulation, ACM Transactions on Graphics (TOG), Volume 28, Issue 3, which is herein incorporated by reference.

In this respect, before explaining a east one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1(a) depicts a representation of alignment constraints selected on an input mesh.

FIG. 1(b) depicts a representation of cross field generation on the input mesh of FIG. 1(a).

FIG. 1(c) depicts a representation of a parametrization computed on the surface of the mesh of FIG. 1(b).

FIG. 1(d) depicts a representation of a consistent, feature aligned quadmesh.

FIG. 2(a) depicts a parametrization of the four cross field directions in a triangle.

FIG. 2(b) depicts a smooth cross field in the vicinity of a cube corner.

FIG. 3(a) depicts three constrained faces as the roots of dual spanning trees covering the Voronoi cells.

FIG. 3(b) depicts a representation of the computation of the cross field directions u_{T}, v_{T}.

FIG. 4 depicts a comparative representation of cross fields obtained on greedy rounding (bottom) v. direct rounding (top).

FIG. 5(a) depicts a representation of the computation of a rotation coefficient via distortion free unfolding.

FIG. 5(b) depicts a representation of a globally consistent orientation in a cross field in a cut mesh v. uncut mesh.

FIG. 6(a) depicts a parametrization not aligned to the sharp edges of the object.

FIG. 6(b) depicts a parametrization wherein the orientation is improved by use of an anisotropic norm.

FIG. 6(c) depicts a parametrization wherein all feature edges are aligned.

FIG. 7(a) depicts a representation of a quadratic energy minimization producing flipped triangles.

FIG. 7(b) depicts a representation of the removal of flipped triangles by local stiffening.

FIG. 7(c) depicts a representation of updated weighting of the triangles.

FIG. 8(a) depicts a representation of an input mesh with bad triangles.

FIG. 8(b) depicts a representation of an input mesh with noisy directions.

FIG. 8(c) depicts a representation of an input mesh of a smooth offset geometry.

FIG. 9 depicts a quadrangulation of a car body using the approach of the present invention.

FIG. 10 depicts a comparison between the quadrangulation approach of the present invention (top) and a quadrangulation approach of the prior art (bottom) applied to a sharp object and a smooth object.

FIG. 11 depicts a comparison between the quadrangulation approach of the present invention (top) and a quadrangulation approach of the prior art (bottom) applied to a ‘rockerarm’.

### DETAILED DESCRIPTION OF PREFERRED EMBODIMENTS

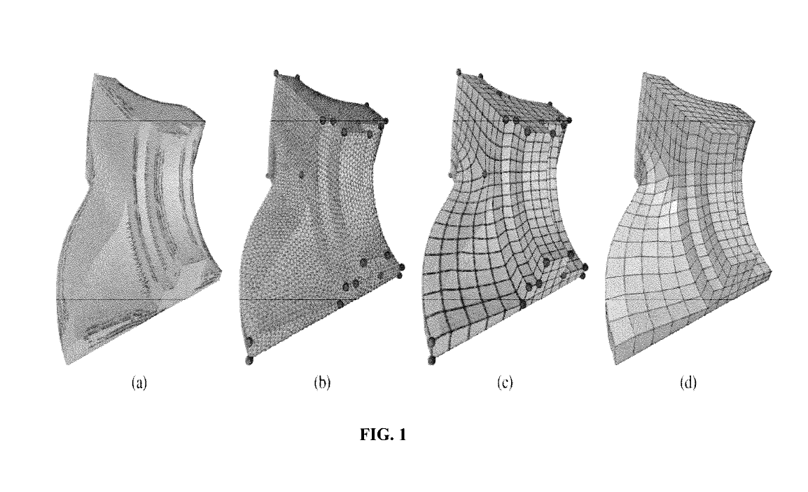

The system and method for generating high quality quadrangulations of the present invention is comprised of a two-step process, namely, cross field generation and global parametrization. With reference to FIG. 1(a), in the cross field generation step, a sparse set of conservatively estimated orientation and/or alignment constraints is selected on an input mesh by some simple heuristic, such as an optimization algorithm, or by a user. Importantly, only the most relevant and dominant directions are selected, as depicted in FIG. 1(a), which can be detected, for example, by conservative thresholding of some anisotropy measure or by manual selection. Starting with these sparsely distributed direction constraints, a search for the smoothest interpolating cross field is conducted. The singularities in this interpolating cross field are mostly due to the surface metric deviating from a planar configuration and not caused by incompatible constraints.

In the second phase of the algorithm, the smooth cross field is used as input for a global parametrization method. With reference to FIG. 1(b), in the global optimization procedure, a cross field is generated on the mesh which interpolates the given constraints and is as smooth as possible elsewhere. The optimization includes the automatic generation and placement of singularities. Next, as shown in FIG. 1(c), a globally smooth parametrization is computed on the surface of the mesh, whose iso-parameter lines follow the cross field directions and singularities lie at integer locations. The mesh is cut open such that a surface patch with a disk-like topology is created where all cross field singularities lie at the boundary. Subsequently, two piecewise linear scalar fields, ti and v, are computed, whose gradients follow the given cross field. Finally, a consistent quadrangulation can be extracted since by construction the parametrization is compatible at the cuts and all singularities are mapped to integer positions along the boundary of the parameter domain. FIG. 1(d) shows a consistent, feature aligned quadmesh ready for extraction. In both steps of the algorithm, the tasks can be formulated in terms of a mixed-integer problem. These are linear problems where a subset of the variables is continuous (εR) and the others are discrete (εZ). A greedy solver for this class of problem is described below.

The minimization of a quadratic energy E(x₁; . . . ; xₙ) is called an integer problem if xεZⁿ and more general problems are encountered where some of the unknown variables x₁ . . . xₖ are integers and the others xₖ₊₁ . . . xₙ are real numbers. Integer and mixed-integer problems are usually very hard to solve exactly. Hence, a common way to find an approximate solution is to first compute the continuous minimizer, which simply requires the solution of the linear system {δE=δxᵢ=0|i=1 . . . n} Then the first k variables of the solution vector are rounded to the nearest integer and a new minimizer is computed by assuming these rounded values x₁ . . . xₖ to be constant.

While this direct rounding is a common practice, depending on the number of integer variables and on their mutual dependencies, the obtained solution can deviate significantly from the true solution. Hence, the system and method of the present invention propose an alternative approach called “greedy rounding”. In greedy rounding, integer variables are rounded one at a time, followed by an immediate update of the continuous part of the solution.

For example, where x⁰ is the continuous solution to the linear system and xᵢ, i≦k is the variable which causes the smallest absolute error if rounded to the nearest integer, then xᵢ can be set to this integer value and the linear system can be updated by assuming xᵢ as constant. Next, we solve again for the remaining variables x¹ and continue to eliminate in each step that variable which causes the least round-off error, until all variables x₁ . . . xₖ have an integer value.

The motivation for this approach is based on the assumption that small round-off errors will only have little impact on the final solution and that by recomputing the free variables after every rounding step these errors will be compensated for. While greedy rounding requires solving k (=number of integer variables)+1 linear systems, which in turn increases the computation time, these small round-off errors only have a limited impact on the solution.

The adaptive mixed-integer solver is a local Gauss-Seidel iteration. For sparse matrices, typically arising in the case of triangle meshes, it is often sufficient to update a small local set of variables. In this context “local” means a short path in the dependency graph of all variables. Using the Gauss-Seidel iteration, after variable xᵢ is rounded, all variables whose Gauss-Seidel update depends on xᵢ are pushed into a queue. These are exactly the nonzero elements of the row Aᵢ. Now, in each iteration step the first element from the queue, say xₖ, is fetched and the local residuum is recomputed in the form below:

$$a . {r}_{k} = {b}_{k} - {\sum }_{j = 1}^{n} {A}_{kj} {x}_{j} \qquad$$

If |rₖ| is larger than a prescribed tolerance, e.g. 10⁻⁶, then the variable xₖ→xₖ→xₖ→rₖ/Aₖₖ is updated and all variables which depend on xₖ are pushed onto the queue. The iteration terminates if the queue is empty, i.e. all local residui are within the prescribed tolerance, or a maximum number of iterations is reached. In this regard, see the table (Algorithm 1) below:

i. Algorithm 1 Local Gauss-Seidel

| 1: xᵢ = round(xᵢ) | |
|---|---|
| 2: push nonzero(Aᵢ) into queue | |
| 3: iter = 0 | |
| 4: while ( (not queue empty) and (iter < maxiter) ) do | |
| 5: | iter = iter + 1 |
| 6: | xₖ = pop( queue ) |
| 7: | rₖ = bₖ − Σⱼ₌₁ⁿ Aₖⱼxⱼ |
| 8: | if (\|rₖ\| > tolerance) then |

| | |
|---|---|
| 9: | xₖ = xₖ − rₖ/ Aₖₖ |
| 10: | push nonzero(Aₖ) into queue |

| | |
|---|---|
| 11: | end if |

12: end while

If the local Gauss-Seidel solver does not converge (iter≧maxiter), a more global Conjugate Gradient solver is utilized and finally, if it is necessary, a sparse Cholesky solver is used. Such time consuming Sparse-Cholesky computations are only necessary when a variable with large impact is rounded. This adaptive solver method has been shown to be more efficient than restricting to pure iterative solvers.

In the vicinity of flat or umbilic points, the principal curvature directions are ill defined. Consequently, using the principal curvature directions as a dense guiding field for quadrangulation leads to suboptimal results. Typical artifacts are noisy directions with badly placed singularities or even clusters of unnecessary singularities. Generally, these artifacts cannot be removed by cross field smoothing algorithms, since the configurations often form local minima. Therefore, in contrast to other methods, the method of the present invention aims at finding the smoothest cross field by interpolating only sparse directional constraints that can be found in a reliable manner.

The directions to be identified are in the spirit of feature lines, however, a simple heuristic which robustly identifies parabolic regions will suffice. Since parabolic regions are equipped with a well-defined orientation they are the best candidates to guide a quadrangulation. Parabolic regions can be identified by measuring the relative anisotropy of the principal curvatures

$$i . τ = \frac{‖ {κ}_{max} \vert - \vert {κ}_{min} ‖}{\vert {κ}_{max} \vert} ∈ [ 0 , 1 ] \\ which is defined to be zero , if {κ}_{max} is zero . \qquad$$

Computing meaningful curvatures on discrete triangle meshes is an involved process. A common technique of the prior art entails evaluating the shape operator of a geodesic disk near a point P. However, depending on the radius r a different set of estimates will be returned. In order to achieve a more stable result, the method of the present invention computes for each point a set of shape operators Sᵣ with different geodesic radii rε[r₀, r₁] and selects the most promising one with a simple heuristic. A shape operator Sᵣ is said to be valid if all shape operators in the interval [r−w, r+w] have a relative anisotropy larger than a prescribed threshold τₘᵢₙ and a mean curvature larger than K to exclude almost flat regions. For all points which provide a valid shape operator, a directional constraint is added. If there are multiple valid candidates for a single point, the one with the most stable direction is chosen (i.e. the one with the minimal angle deviation within its interval).

Fortunately, all necessary coefficients of this heuristic have an intuitive meaning. Appropriate directions should be stable within a range depending on the target edge length h. Following this observation, width w is set at w=h/4. Furthermore, r₀ is set as the average length of all triangle edges, r₁=h, τₘᵢₙ=0.8 and K=0.1/bₛ, where bₛ is the radius of a bounding sphere. In general, the quadrangulation result is not very sensitive with respect to these parameters, since similar cross fields can be generated with a large range of different sparse constraints, generated with slightly different parameters.

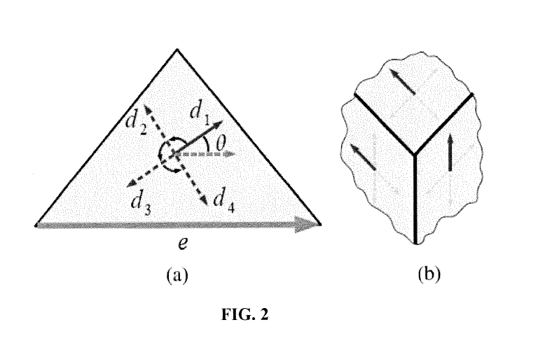

In order to generate smooth cross fields, the elegant formalism for N-Symmetry direction fields is utilized wherein a cross field (N=4) on a triangle mesh M=(V,E,F) is defined by an angle-field θ: F→R assigning a real number to each face and a period-jump field p E→Z assigning an integer to each edge. The main idea is to use the angles θ to determine a single unit length vector-field which then extends to a symmetric cross field by applying three rotations of π/2 as shown in FIG. 2(a), an illustration of the four cross field directions in a triangle as parameterized by the angle θ with respect to a local reference edge e. Because a cross consists of four vectors between neighboring triangles it is necessary to identify which vector of the first cross is associated with which vector of the second cross. All these topological issues are handled by the period-jumps, as illustrated in FIG. 2(b) for a smooth cross field near the corner of a cube. In FIG. 2(b), the bold solid arrows reflect the corresponding period jumps.

After fixing the topology, measuring the smoothness of a cross field reduces to measuring the smoothness of one of the four rotation symmetric vector-fields. The smoothness of a unit vector-field can be measured as the integrated squared curvature of the direction field. On a discrete triangle mesh, this measurement turns out to be simply the sum of all squared angle differences between neighboring triangles:

$$a . {E}_{smooth} = {\sum }_{{e}_{ij} ∈ E} {( {θ}_{i} - {θ}_{j} )}^{2} \qquad$$

where θᵢ is the angle of triangle i and neighboring angles are represented in a common coordinate frame, which is always possible by flattening both triangles along their common edge. However, for a surface with non-zero Gaussian curvature it is not possible to find a global coordinate frame. Therefore, a local coordinate frame is used for each triangle, where the x axis is identical to the first edge e of the triangle, shown in FIG. 2(a). Thus, by incorporating the coordinate transformations between neighbors the smoothness energy of a cross field can be expressed as:

$$i . {E}_{smooth} = {\sum }_{{e}_{ij} ∈ E} {( \underbrace{{θ}_{i} + {κ}_{ij} + \frac{π}{2} {p}_{ij}}_{{θ}_{t} w . r . t . frame j} - {θ}_{j} )}^{2} \\ where {κ}_{ij} ∈ ( - π , π ] is the angle between both local \\ frames and {p}_{ij} is the integer valued period jump across \\ edge {e}_{ij} . The cross field index of a vertex can be \\ computed as \\ I ( {v}_{i} ) = {I}_{0} ( {v}_{i} ) + {\sum }_{{e}_{ij} ∈ N ( {v}_{i} )} \frac{{p}_{ij}}{4} \\ with the constant integer valued base index \\ {I}_{0} ( {v}_{i} ) = \frac{1}{2 π} ( {A}_{1 d} ( {v}_{i} ) + {\sum }_{{e}_{ij} ∈ N ( {v}_{i} )} {κ}_{ij} ) \\ and {A}_{d} ( {v}_{i} ) is the angle defect of vertex {v}_{i} . Only \\ singularities of the cross field have a nonzero index which is always a multiple of \frac{1}{4} [ Ray et al . 2008 b ] , e . g . \frac{1}{4} and \\ - \frac{1}{4} for quadrangulation configurations corresponding to \\ valence 3 and 5 respectively . \qquad ( 1 )$$

Using these basic definitions, the optimization problem for generating a smooth cross field can be formulated. Given a mesh M and a subset of faces F_{c} c F with constrained directions θᵢ=̂θᵢ, a search is conducted for the smoothest interpolating cross field (i.e. in an effort to minimize (1)). Accordingly, an integer pᵢⱼ per edge and a real valued angle θᵢ per face are sought.

At the next stage, the search space is reduced from the whole space of equivalent minimizers to the energy (1). For example, assuming a minimizer has already been computed which for one triangle provides the angle θ₀ and the three period jumps p₀₁, P₀₂ and p₀₃. If the vector is now rotated by a multiple of π/2, i.e. set ˜θ₀=θ₀+k·π/2 and this change is compensated by updating the affected period jumps to ˜p₀ᵢ=p₀ᵢ−k, then the smoothness energy is unchanged. This procedure can be repeated for all free triangles fεF\F_{c}. Consequently the solution can be made unique by fixing one period jump per free triangle to an arbitrary value, e.g. zero, without changing the energy of the minimizer. Note that care should be taken not to fix edges whose dual path connects two constrained faces or closes loops because in these cases the cross field curvature along this path would be fixed to an arbitrary value and this is not the intended result of the minimizer.

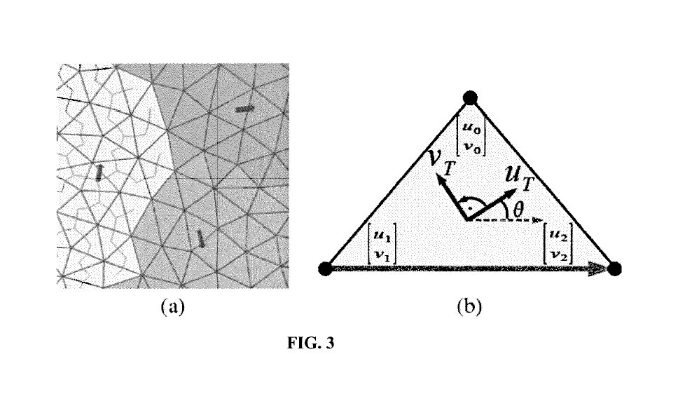

A valid set of edges, whose period jumps are allowed to be set to zero, can be found by constructing a forest of Dijkstra trees of the dual mesh as shown in FIG. 3. In FIG. 3(a), the three constrained faces associated with the arrows are the roots of dual spanning trees which cover the respective Voronoi cells. Each cell contains only one constraint and along all branches of the tree zero period jumps can be propagated without changing the total smoothness energy. In FIG. 3(b), with the angle θ with respect to the local reference direction, the cross field directions u_{T}, v_{T} can be extracted and used for the parametrization. In the computation two linear scalar functions (u, v) are sought whose gradients are oriented consistently with the cross field directions.

Each constrained face in F_{c} is the root of a separate tree such that no tree connects constrained faces. The number of fixed edges is exactly |F\F_{c}| since starting from the constrained faces each other face of the mesh is conquered by adding a single edge. Note that no dual loop can be closed by a tree structure, such that a valid set of edges are produced which can be fixed to zero period jumps without changing the energy of the minimizer.

While there are other valid sets of edges which could be fixed, trees living in the discrete Voronoi cells of the corresponding constrained faces are utilized since this minimizes the length of a path to its corresponding constraint and so improves the accuracy of the greedy mixed-integer solver. Additionally to the period jumps on tree edges each period jump between two adjacent constrained faces fᵢ and fⱼ can be fixed to:
pᵢⱼ=round(2/π(\hat{θ}ⱼ−\hat{θ}ᵢ−κᵢⱼ)), since pᵢⱼ is only part of a single quadratic term in (1), which is independent from other variables.
In summary we end up with a mixed-integer problem consisting of |F\F_{c}|≈2|V| real valued variables θᵢ and |E|−|F\F_{c}|≈|V| integer valued variables pᵢⱼ.
i.

To apply the greedy mixed-integer solver, it is sufficient to assemble the system of linear equations by setting the gradient of the energy (1) to zero:

$$\begin{matrix}i . \frac{\partial {E}_{smooth}}{\partial {θ}_{k}} = {\sum }_{{e}_{kj} ∈ N ( {f}_{1} )} 2 ( {θ}_{k} + {κ}_{kj} + \frac{π}{2} {p}_{kj} - {θ}_{j} ) {=}^{∣} 0 & ( 2 ) \\ \frac{\partial {E}_{smooth}}{\partial {p}_{ij}} = π ( {θ}_{i} + {κ}_{ij} + \frac{π}{2} {p}_{ij} - {θ}_{j} ) {=}^{∣} 0 & ( 3 )\end{matrix}$$

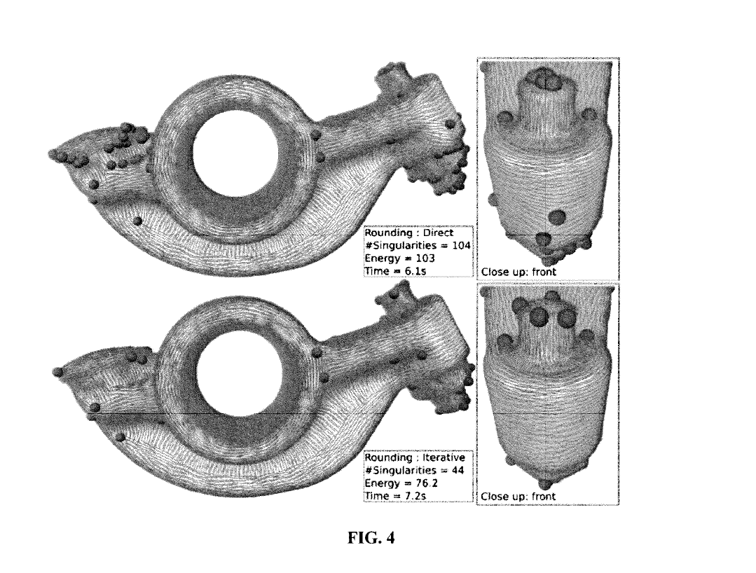

Notice that the values on edges are antisymmetric, i.e. pᵢⱼ=−pⱼᵢ and κᵢⱼ=−κⱼᵢ, which can lead to sign changes in equations (2) and (3), above. For all variables which are not fixed, a row is set up and all of these variables are assembled into a single matrix. After applying the greedy mixed-integer solver, the result is a smooth cross field where the integer valued period jumps define the type and position of all singularities. FIG. 4 depicts a comparison of the results of the greedy rounding (bottom) with that of a direct rounding (top), where the different shaded spheres represent singularities with negative and positive index respectively. Note that the greedy rounding yields a smaller smoothness energy (76.2 v. 103) and fewer singularities (44 v. 104), whereas the direct rounding produces unnecessary singularities and a higher energy. Further note that these are the singularities and the field as they emerge from the solver. No singularity optimization has been carried out. Taken together, the example in FIG. 4 demonstrates that greedy rounding leads to a significantly smoother cross field with fewer singularities in comparison to the direct rounding approach.

In practice, some singularity positions, especially those in flat regions, can be optimized/improved through the use of a local search algorithm, as described below.

In a form of post-processing, each singularity can be optionally checked to determine whether the energy can be decreased by moving it to a neighboring vertex. Moving a singularity along an edge eᵢⱼ means changing the corresponding period jump pᵢⱼ. By this operation, only the right-hand-side of the linear system is changed. Consequently, the sparse Cholesky factorization of this matrix can be pre-calculated once, following which solutions for different right-hand-sides can be computed efficiently.

Proceeding to the global parametrization step, a global parametrization, i.e., a map from the given mesh M to some disk-shaped parameter domain ΩεR², is computed. Since the parametrization should be piecewise linear, it is sufficient to assign a (u, v) parameter value to each vertex—more precisely to each triangle corner—in the mesh.

The parametrization should be locally oriented according to the optimized cross field, as previously described, which implies that the gradients of the piecewise linear scalar fields u and v defined on the mesh M should minimize the local orientation energy

E_{T}=∥h∇u−u_{T}∥²+∥h∇v−v_{T}∥²
1.

for each triangle T, where h is a global scaling parameter which controls the edge length of the resulting quad mesh. The vectors u_{T} and v_{T} are two orthogonal vectors in T corresponding to the cross field directions θ and θ+π/2. Since the cross field is defined only up to rotations by π/2, which of the four possibilities to be selected in each triangle must be specified, such that the proper compatibility conditions are satisfied across each edge in the mesh.

The global orientation energy is then defined as the integral of E_{T} over the entire mesh M

$$i . {E}_{orient} = {\int }_{ℳ} {E}_{T} d A = {\sum }_{T ∈ ℳ}^{ } {E}_{T} area ( T ) . \qquad ( 4 )$$

The minimizer of this quadratic functional is obtained by solving the sparse linear system which sets all the partial derivatives of Eₒᵣᵢₑₙₜ to zero.

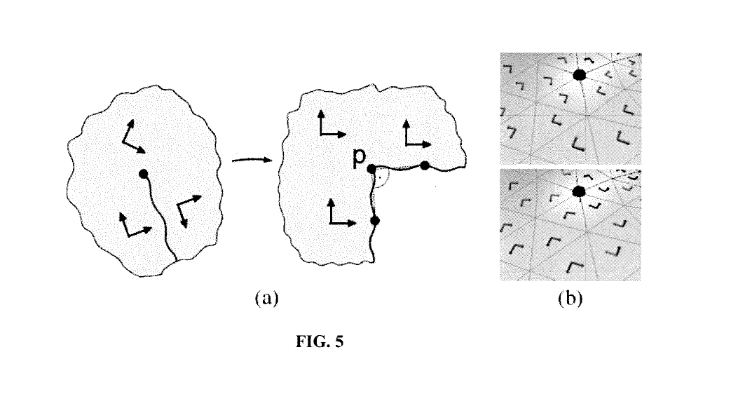

In order to be able to compute a proper parametrization minimizing Eₒᵣᵢₑₙₜ, the mesh M may be cut open, such that a patch that is topologically equivalent to a disk is obtained. An additional requirement is that all singular vertices must lie on the cut, i.e. at the boundary of the parameter domain. The reason for this requirement is that the angle defect of a singularity cannot be represented by an inner vertex of the parametrization as depicted in FIG. 5. In particular, FIG. 5(a) illustrates that by placing a cut to a cone of singularity p, a distortion free unfolding of the patch is possible. In FIG. 5(b), in the upper image two directions of the cross field are shown, while in the lower image, the mesh is cut into disk topology, such that these directions can be consistently oriented on each side of the cut.

An appropriate graph is computed in two steps. First, starting from a random triangle, a topological disk is grown by constructing a dual spanning tree. Thus the primal of all non-spanning tree edges is already a cut graph which transforms M into disk topology. The size of this cut graph can be significantly reduced by iteratively removing all open paths.

In the second step, paths connecting each singularity to the cut graph are added. This can be done by successively applying Dijkstra's shortest path algorithm. At the end of the two cutting steps, the result is a triangle mesh patch where all the singularities are located at the boundary. If a singularity is not a leaf node of the cut graph then it appears several times along the boundary. In order to compute a parametrization, a planar embedding of this boundary polygon as well as all the interior vertices must be found. The location of the mesh vertices in the parameter domain is computed by minimizing Eₒᵣᵢₑₙₜ, however, there are a number of consistency constraints that have to be taken into account.

By allowing a singularity to be in general position, it would cause an n-sided face instead of a valence-n vertex. Therefore, to guarantee a pure quadrangulation, all singularities must be snapped to integer locations in the parameter domain. This means that the overall parametrization task becomes a mixed-integer problem which is solve by the mixed-integer greedy solver, as previously described.

In order to avoid visible seams across the cut paths on the surface, it must be ensured that the quad structure on both sides of a cut edge is compatible. This is guaranteed by allowing only a grid automorphism as a transition function. This requires that the (u, v) parameter values on both sides of a cut edge are related by:

(u′,v′)=Rot₉₀ⁱ(u,v)+(j,k)
with integer coefficients (i, j, k).
i.

The rotation coefficient in the transition functions can easily be computed by propagating a globally consistent orientation in the cross field, as illustrated in FIG. 5. Since after the cutting, all interior vertices of the mesh are regular, one can start at a random face and propagate its orientation in a breadth first manner to all the neighboring faces. This will establish a zero-rotation across all inner edges. The rotations Rot₉₀ⁱ across the cut edges can be found by simply comparing the orientations in neighboring faces.

After fixing the rotations, the cross boundary compatibility conditions can be incorporated into the optimization scheme as linear constraints. Therefore, for each cut edge e=p q, two integer variables jₑ, kₑ are introduced to formulate the four compatibility conditions:

(uₚ′vₚ′)=Rot₉₀ⁱ^{ₒ}(uₚ,vₚ)+(jₑ,kₑ)

(u_{q}′,v_{q}′)=Rot₉₀ⁱ^{ₒ}(u_{q},v_{q})+(jₑ,kₑ)

In total, two integer variables are added and four continuous variables are eliminated per cut edge.

Applying the mixed-integer greedy solver to this parametrization task can be understood in an intuitive way. After computing an all-continuous solution, which corresponds to the unconstrained parametrization, the singularities are iteratively snapped to integer locations.

In practice, exact orientation is often more important than exact edge length. The reason for this is that by changing the orientation along a highly curved feature line, the quadrangulation quality will drop off dramatically due to normal noise. The orientation can be improved by less penalizing stretch which is in the direction of the desired iso-lines. This can be achieved by an anisotropic norm

∥(u,v)∥_{(α,β)}²=αu²+βv²
1.

which penalizes the deviation along the major directions with different weights. Notice, such a diagonal metric is sufficient since (u_{T}, v_{T}) are used as the local coordinate frame in each triangle.

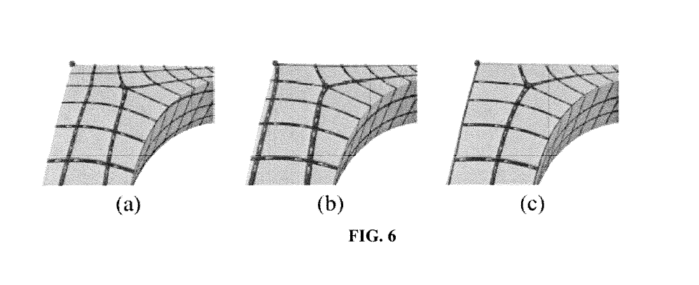

E_{T}=∥h∇u−u_{T}∥_{(γ,1)}²+∥h∇v−v_{T}∥_{(1,γ)}²
with γ≦1. FIG. 6 (b) shows an example, where the orientation of the parametrization is improved by using the anisotropic norm.
i.

Sharp feature lines of the input mesh should be preserved in the quadrangulation. Given a subset S c E of triangle mesh edges, the necessary alignment conditions can be incorporated in a straightforward way. First of all, alignment requires correct orientation. Therefore, while computing the cross field, all edges in S are used as orientational constraints in both adjacent triangles. Additionally, to the correct orientation for alignment, a constant integer coordinate along the edge is necessary, which guarantees that this edge is preserved in the quadrangulation. Each alignment condition for an edge p q can be formulated independently. If the cross field direction u_{T} is already oriented along the alignment edge, a simple condition for the v parameter values results

vₚ=v_{q}ε [symbol]
i.

which ensures that p q is mapped to an integer valued iso-line. The u=const case is handled analogously. Consequently, for each alignment edge a single variable can be eliminated and the remaining integer variables can be handled by the greedy mixed-integer solver. Referring to FIG. 6, the parametrization in (a) is not aligned to the sharp edges of the object. Using the anisotropic norm the quads are allowed to stretch in order to better align with a given input field

as shown in (b). In (c) alignment constraints have been imposed, leading to perfectly preserved features (i.e. all feature edges are aligned), while preventing jagged boundary lines.

By computing a parameterization with the given target edge length h, new requirements have to be taken into account which cannot be anticipated by the cross field computation, since it is independent from h. Examples are singularities which are too close to each other, a boundary or a given alignment edge. Other aspects are symmetries which are irrelevant for a smooth cross field, but important for a quadrangulation. Therefore, to achieve maximal quality it can be necessary to relocate the singularties with respect to the requirements of the parameterization. This can be done with a local search algorithm similar that previously described under the post-processing singularity optimization step of the cross field computation stage. Depending on how much time is available, the search can be optionally restricted to the best local candidate, i.e. the closest neighbor in the parametrization v. evaluating the quality of all neighbors. In each step it is necessary to recompute the smooth cross field with respect to the relocated singularity as well as the parametrization. In the cross field computation, the cross field indices are now prescribed by linear constraints. Movements are performed if the overall quality improves, i.e. the energy (4) decreases.

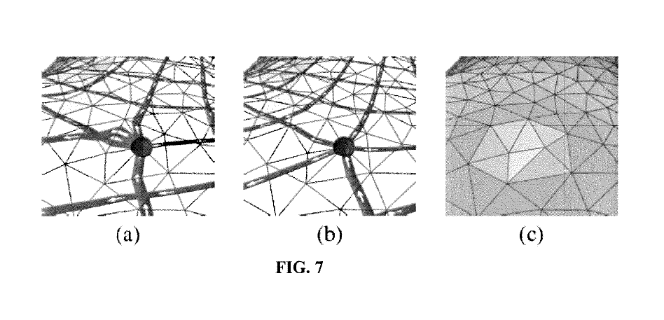

Parametrization is the result of a quadratic energy minimization. Thus, despite the global optimum, for a few triangles it might happen that the metric distortion gets very high or even worse, that the orientation of a mapped triangle flips. FIG. 7 shows an example where such a problem occurs in the vicinity of a singularity. In FIG. 7(a), it is shown that the minimized orientation energy produces flipped triangles. In FIG. 7(b), it is shown that the flipped triangles can be removed by local stiffening. The chosen weighting is shown in FIG. 7(c). The idea of local stiffening is to add an adapted triangle weighting w(T) into the energy formulation to penalize high local distortions, yielding:

$$1. {E}_{orient} = {\sum }_{T ∈ ℳ} w ( T ) {E}_{T} area ( T ) . \qquad$$

This weighting, which is initialized to one, can be updated iteratively, as described in the following part, until the quality of the parametrization is sufficient.

The metric distortion is characterized by the singular values σ₁ and σ₂ of the Jacobi matrix. Furthermore, to penalize flips the orientation of a triangle is evaluated as

$$1. τ = sign ( det [ \begin{matrix}{u}_{1} - {u}_{0} , {u}_{2} - {u}_{0} \\ {v}_{1} - {v}_{0} , {v}_{2} - {v}_{0}\end{matrix} ] ) \qquad$$

where (uᵢ, vᵢ) are the vertex parameter coordinates in counterclockwise ordering.

Local distortion of each triangle is measured by the equation

$$a . λ = \vert τ \frac{{σ}_{1}}{h} - 1 \vert + \vert τ \frac{{σ}_{2}}{h} - 1 \vert \qquad$$

which respects the edge length h. Finally, the weight of a triangle is updated by evaluating a uniform Laplacian defined on the dual mesh

w(T)←w(r)+min{c·|Δλ(T)|,d}
2.
   with the proportionality constant c and a maximal allowed update of d, chosen as c=1 and d=5 in all of the examples. Note that directly using the distortion instead of the Laplacian would not be a good idea, since the weighting would reflect the global stretch distribution, which is necessary for a globally consistent quadrangulation, instead of the desired local distortions. Subsequently, the smoothness of the weighting field w(T) is increased by a few uniform smoothing steps, which in general leads to nicer quadrangulations.

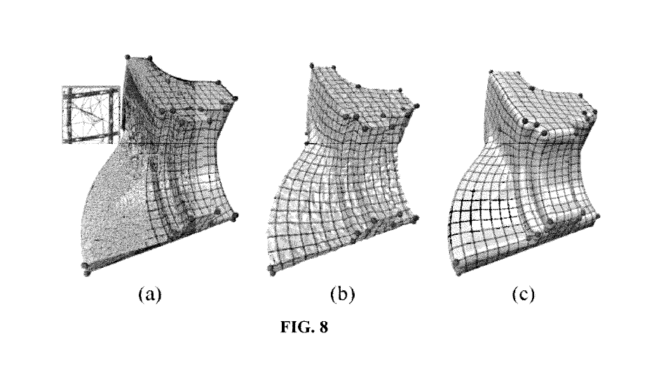

FIG. 8 demonstrates the robustness of the mixed-integer quadrangulation approach with respect to different (degenerate) representations of a given object. The mesh in FIG. 8(a) contains almost 1000 triangles with vanishing area (the close-up shows a part of the mesh where about eight (8) triangles are nearly colinear), i.e. bad triangles, the model in FIG. 8(b) has been subjected to normal noise with a magnitude of 0.3% of the bounding box diagonal and the right most model (FIG. 8(c)) was offset, yielding a mesh without sharp corners.

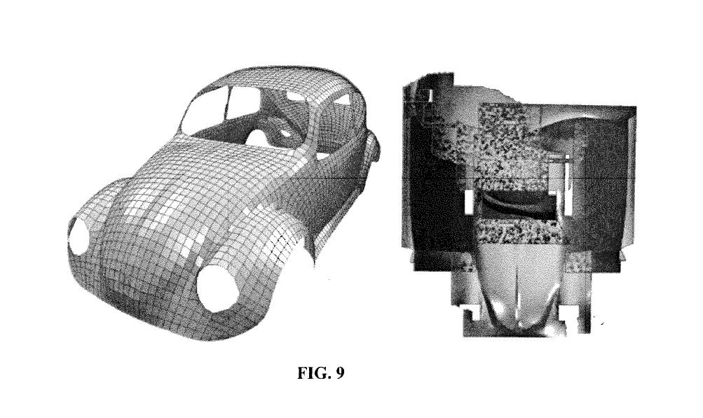

FIG. 9 depicts a representation of the quadrangulation of a car body having eleven (11) bodies in accordance with the system of the present invention. On the right, the parametrization is shown.

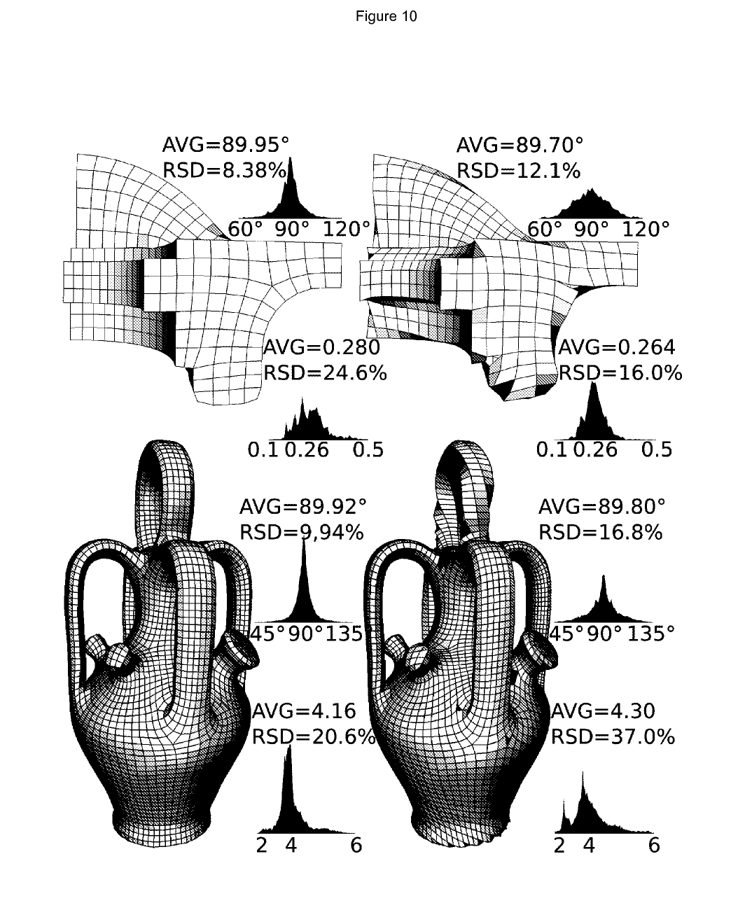

A comparison between the quadrangulation approach of the present invention (left) and the QuadCover approach (right) [see K\ddot{}alberer et al., 2007. Quad-cover-surface parametrization using branched coverings, Computer Graphics Forum, 26, 3 (September). 375-384] is depicted in FIG. 10. In both examples, the same input cross field and target edge length have been used. The sharp object (fandisk—above) comparison clearly shows the benefit of alignment on models with sharp feature edges, while the limitations of direct rounding are especially noticeable on the smooth object (bojito—below). On complex objects having many singularities or when remeshing with very coarse target edge length the direct rounding generates many “twists” and non-injectivities in the parametrization, such that the extraction of a hole-free quad mesh is not always possible. However, the combination of the greedy rounding and local stiffening procedure taught herein allow automatic generation of consistent, hole-free quadrangulations at almost any resolution and with significantly less “twists”.

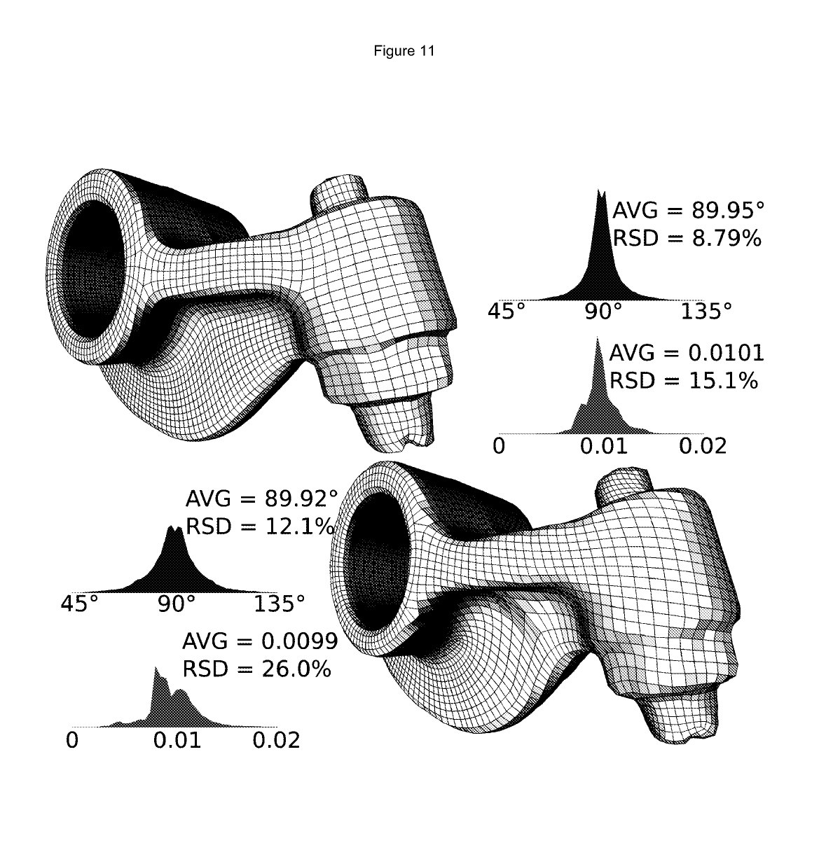

The spectral approach [see Huang et al., 2008, Spectral quadrangulation with orientation and alignment control, ACM Trans. Graph, 27, 5, 1-9] also produces oriented and aligned parametrizations with few singularities, however the Morse-Smale Complex sometimes fails to capture the detailed structure of the surface. This can lead to an unfavorable stretch of the quads affecting the angle as well as the edge length distribution. A comparison between the spectral approach (top) and the approach of the present invention (bottom), as applied to a rockerarm is illustrated in FIG. 11. The top mesh has 9413 faces and 36 singularities, while the bottom mesh has 9400 faces and 26 singularities.

The present invention also includes a computer system and a computer program, implementing the method of the present invention and thereby providing a computer system and a computer program for generating high quality quadrangulations by re-meshing 3D models, as described above.

The computer system of the present invention may include a computer system deployed within a computer infrastructure. The computer system could be implemented within any computer network environment (e.g., the Internet, a wide area network (WAN), a local area network (LAN), a virtual private network (VPN), etc.), or on a stand-alone computer system. The computer system of the preset invention may also be implemented based on cloud computing methods, thereby offering the functionality described as a service provisioned by the “cloud”.

The computer system, as a stand-alone computer system includes a processing unit for executing computer program code, such as a quad meshing utility including functionality for processing the method steps described above.

Still further, it is understood that one or more additional components (e.g., system software, math coprocessing unit, etc.) can be included in computer system. The computer system may consist of any manner of computer device including a desktop computer, laptop computer, tablet computer or wireless handheld.

The computer system may include or be linked to a database, and optionally a database management utility. The database enabling the storage and retrieve of 3D models, and after processing of the 3D models by operation of the present invention, storage of the re-meshed 3D models to the database for further use in a 3D model creation or modification workflow.

It should be understood that the present invention may be implemented to a larger platform, system, or set of tools used in a 3D model creation of modification workflow, in which case such platform, system, or set of tools provides the system of the present invention.

The present invention may also be implemented as a computer-readable/useable medium that includes computer program code to enable a computer infrastructure to provide quadrilateral re-meshing of a 3D model. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory associated with a computer and/or a storage system.

It should be understood that access to the functions of the present invention may be linked to a variety of business models for leveraging same including providing access to the functions to a user base on a subscription, advertising, and/or fee basis.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

What is claimed is:

1. A computer-implemented method for quadrangulating an input mesh comprising:
selecting a set of orientation constraints on the mesh;
generating a cross field on the mesh by interpolating the orientation constraints;
generating a plurality of singularities at geometrically meaningful locations on the mesh; and
computing a smooth parametrization on the surface of the mesh.

2. The method of claim 1, wherein a set of sparsely selected orientation constraints is selected.

3. The method of claim 1, wherein each of the plurality of singularities lies at an integer location on the mesh.

4. The method of claim 1, wherein the parametrization computation step further includes the step of placing iso-parameter lines on the surface of the mesh.

5. The method of claim 4, wherein the iso-parameter lines follow the directions of the cross field.

6. The method of claim 1, wherein the parametrization computation step further includes the step of cutting the mesh open in order to enable a low distortion unfolding.

7. The method of claim 6, wherein the mesh is cut open to create a surface patch having a boundary portion and a disk-like topology.

8. The method of claim 7, wherein each of the plurality of singularities lies along the boundary portion.

9. The method of claim 1, wherein the parametrization computation step is performed by an adaptive greedy solver.

10. The method of claim 9, wherein the adaptive greedy solver iteratively rounds integer variables located at the boundary portion.

11. The method of claim 1 wherein the orientation constraints are selected manually by a user.

12. The method of claim 1 wherein the orientation constraints are selected by an algorithm.
A computer system for quadrangulating an input mesh comprising:
an input device for receiving an at least one input mesh;
a processing unit in communication with the input device, the processing unit configured to:
receive the at least one input mesh from the input device;
select a set of orientation constraints on the at least one input mesh;
generate a cross field on the at least one input mesh by interpolating the orientation constraints;
generate a plurality of singularities at geometrically meaningful locations on the at least one input mesh; and
compute a smooth parametrization on the surface of the at least one input mesh.
